(19) United States
(12) Patent Application Publication
(10) Pub. No.: US 2024/0136832 A1
(43) Pub. Date: Apr. 25, 2024

(54) SAFETY SYSTEM FOR BATTERIES AND SUPERCAPACITORS

(71) Applicant: Sohail Khan, Peshawar (PK)

(72) Inventor: Sohail Khan, Peshawar (PK)

(21) Appl. No.: 18/098,559

(22) Filed: Jan. 18, 2023

Related U.S. Application Data
(60) Provisional application No. 63/418,337, filed on Oct. 21, 2022.

(51) Int. Cl. H02J 7/00; H01M 10/42; H01M 10/48; H02J 7/34

(52) U.S. Cl. CPC H02J 7/0029; H01M 10/4264; H01M 10/482; H01M 10/486; H02J 7/0013; H02J 7/0047; H02J 7/007188; H02J 7/345; H01M 2010/4271

(57) ABSTRACT

A safety system and method for batteries to protect the batteries from damage and fire. The safety system includes a micro pressure sensor to detect a pressure of the battery and a micro temperature sensor to detect the temperature of the battery. The system can cease the charging and/or discharging of the battery when the current temperature or pressure of the battery exceeds a threshold temperature or pressure respectively. The housing of the safety system is filled with a thermally conductive epoxy to dissipate the heat. The system further includes a load resistor to slowly discharge the faulted battery.

### CROSS-REFERENCE TO RELATED APPLICATIONS

This application claims priority from a U.S. provisional patent application Ser. No. 63/418,337, filed on Oct. 21, 2022, which is incorporated herein by reference in its entirety.

### FIELD OF INVENTION

The present invention relates to a system and method for battery management, and more particularly, the present invention relates to a safety system and method for batteries and supercapacitors.

### BACKGROUND

The use of batteries is widespread. Batteries and supercapacitors are used in many electronic devices throughout the world. Also, batteries and supercapacitors of high charge density are generally preferred in most electronic devices. The use of high-charge density batteries is rising, and also efforts are being made to decrease the battery size and charging time. However, incidences of battery failure, fires due to battery failure, and explosions in worst-case scenarios are also becoming common. Typically, the batteries and supercapacitors heat up due to improper charging or discharging which may lead to fire and explosion. The use of defective chargers is the main cause behind battery heating up leading to fires. Other reasons include faulty electronic devices that may draw current at a very fast rate, incompatible chargers or electronic devices, inadequate charging voltages, short circuits, and physical damage to the batteries. Battery failure or short circuit due to any of the reasons can cause the electrodes of the battery/supercapacitor to heat up, degrading of the electrode active coated material due to high temperature and pressure, and/or evaporation of the electrolyte.

To avoid aforesaid scenarios, battery management has become an important field of research. Thus, an industrial need is there for improved hardware, software, and interfaces for battery management.

Hereinafter, the terms “batteries” and “super capacitors” are interchangeably used, and references to batteries include supercapacitors. The batteries are preferably rechargeable batteries.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for battery management that stops charging and/or discharging batteries when a predefined condition or event is detected.

It is another object of the present invention that the failed batteries are kept in a dormant state of slow and safe discharge.

It is still another object of the present invention that the incidences of fire and explosion due to failed batteries can be prevented.

It is yet another object of the present invention that the damage to electronic devices due to the failed battery can be avoided.

It is a further object of the present invention that the life of the battery can be maintained or extended.

It is still a further object of the present invention that the system consumes very less power.

It is an additional object of the present invention that the system can be energy efficient by switching between passive mode and active mode.

It is still an additional object of the present invention that the system is integrated with the battery.

It is yet an additional object of the present invention that the manufacturing of the system can be easily scaled up.

In one aspect, disclosed is a safety system for batteries and/or supercapacitors, the safety system comprises a housing; a controller encased within the housing, the controller configured to cease charging and/or discharging of one or more battery cells, the controller is configured with a threshold temperature and a threshold pressure for the one or more battery cells; a pressure sensor configured to determine a current pressure of the one or more battery cells in near real-time; a temperature sensor configured to sense a current temperature of the one or more battery cells in near real-time; a logic circuitry operably coupled to the pressure sensor and the temperature sensor, the logic circuitry configured to compare the current temperature and the current pressure of the one or more battery cells to the threshold temperature and the threshold pressure respectively, the logic circuitry operably coupled to the controller, wherein the controller is configured to: receive a signal from the logic circuitry, the signal indicative of the current temperature or the current pressure exceeding the threshold temperature or the threshold pressure respectively; and in response to the signal, ceasing the charging and/or discharging of the one or more battery cells. The safety system further comprises: a load resistor configured to dissipate energy as heat, wherein the control unit is configured to: in response to the signal, place the one or more battery cells in a dormant state and slowly cause the one or more battery cells to discharge through the load resistor. The safety system further comprises one or more MOSFETS, the one or more MOSFETS operably coupled to the control unit and configured to stop the charging and/or discharging of the one or more battery cells. The safety system further comprises a thermally conductive epoxy, the housing is filled with the thermally conductive epoxy.

In one implementation, the battery is a power bank, the one or more battery cells comprise a plurality of battery cells, wherein the control unit is configured to isolate a single battery cell of the plurality of battery cells of the power bank.

In one implementation, the battery is a standalone battery, the one or more battery cells comprises a single cell, and the safety system is configured to be encased with a shell of the standalone battery. The housing is in contact with the shell for dissipating heat to the shell.

In one aspect, disclosed is a method for enhancing safety of batteries and/or supercapacitors, method comprises: providing a safety system comprising: a housing; a controller encased within the housing, the controller configured to cease charging and/or discharging of one or more battery cells, the controller is configured with a threshold temperature and a threshold pressure for the one or more battery cells; a pressure sensor configured to determine a current pressure of the one or more battery cells in near real-time; a temperature sensor configured to sense a current temperature of the one or more battery cells in near real-time; a logic circuitry operably coupled to the pressure sensor and the temperature sensor, the logic circuitry configured to compare the current temperature and the current pressure of the one or more battery cells to the threshold temperature and the threshold pressure respectively, the logic circuitry operably coupled to the controller, wherein the controller is configured to: receive a signal from the logic circuitry, the signal indicative of the current temperature or the current pressure exceeding the threshold temperature or the threshold pressure respectively; and in response to the signal, ceasing the charging and/or discharging of the one or more battery cells.

In one aspect, disclosed is a battery comprising: a safety system for keeping the battery safe, the safety system comprises: a housing; a controller encased within the housing, the controller configured to cease charging and/or discharging of one or more battery cells, the controller is configured with a threshold temperature and a threshold pressure for the one or more battery cells; a pressure sensor configured to determine a current pressure of the one or more battery cells in near real-time; a temperature sensor configured to sense a current temperature of the one or more battery cells in near real-time; a logic circuitry operably coupled to the pressure sensor and the temperature sensor, the logic circuitry configured to compare the current temperature and the current pressure of the one or more battery cells to the threshold temperature and the threshold pressure respectively, the logic circuitry operably coupled to the controller, wherein the controller is configured to: receive a signal from the logic circuitry, the signal indicative of the current temperature or the current pressure exceeding the threshold temperature or the threshold pressure respectively; and in response to the signal, ceasing the charging and/or discharging of the one or more battery cells.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating the architecture of the disclosed system, according to an exemplary embodiment of the present invention.

FIG. 2 is a partially exploded view of a battery with the disclosed system, according to an exemplary embodiment of the present invention.

FIG. 3 is a circuit diagram of an implementation of the disclosed system, according to an exemplary embodiment of the present invention.

FIG. 4 is a circuit diagram of an alternative implementation of the disclosed system, according to an exemplary embodiment of the present invention.

FIG. 5 is a circuit diagram showing the implementation of a load resistor, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a system and method for the safety management of batteries and supercapacitors. The disclosed system can keep the batteries safe and prevent fire or explosion by detecting certain conditions or events and stopping the operation of the battery in near real-time. The conditions or events can be pre-defined and are indicative of potential damage to the battery. Such conditions or events may include a threshold temperature or pressure. The occurrence of such conditions may not result in battery failure, but a possible battery failure may be anticipated. Suitable proactive measures can be taken by the system to prevent failure or failures in the battery. The term failure herein includes any undesirable change in the operation of the battery or undesirable change in the structure or composition of the battery that may irreversibly deteriorate the battery, increase in temperature of the battery to dangerous levels, or increase the pressure of the battery to dangerous levels. Such dangerous levels can result in fire or explosion. Thus, the disclosed system and method can make the batteries and supercapacitors safe to use.

The disclosed system can be made integral to the batteries. The disclosed system can be incorporated into a battery without significantly affecting the size of the battery or requiring significant modifications to the structure of the battery. The disclosed system can be very compact and consumes a very less or insignificant amount of power. Moreover, the components of the disclosed system are readily available, and the disclosed system can be very economical to manufacture and adapt for different batteries.

The disclosed system includes a micro-Pressure sensor that can detect the pressure within the battery cells. Also, the disclosed system can include a micro temperature sensor for detecting the temperature of the battery cells. The temperature sensor and the pressure sensor can be encased in a protective and sealed housing. The housing can be electrically isolating but thermally conductive, such as any heat generated can be dissipated. For example, the housing can be filled with thermally conductive and electrically insulative epoxy. It is understood that the housing can be made to have a specific shape and structure and filled with a thermally conductive material. Alternatively, the housing can be virtually formed by the filling material, such as epoxy. In either case, the heat from the modules including the PCB and load resistor can be dissipated to the shell of the battery/supercapacitor, keeping the module and PCB cool. Such arrangement may be critical for keeping the system compact and economical. This may allow the disclosed system to be incorporated without significantly modifying the size of the batteries. For example, the dimensions of the disclosed system can be less than 16 mm in diameter×10 mm in height, and the weight of the system can be less than about 5 grams.

The disclosed system can be switched between an active mode and a passive mode. The system can be switched from the passive mode to the active mode upon the occurrence of a pre-defined condition or event. For example, the temperature of the battery sensed by the temperature sensor upon reaching a threshold temperature can trigger the system to switch from the passive mode to the active mode. In passive mode, the disclosed system consumes a very less or insignificant amount of power. It is understood that the essential modules including the sensors and logic circuitry may remain operational in the passive mode to detect the temperature and pressure, and to determine the occurrence of pre-defined conditions/events. In the active state also, the disclosed system consumes very less power, such as less than 10 mW.

The disclosed system can be connected to the charging/discharging circuitry of a standard battery using a controller/microcontroller and MOSFET switches. The controller can be operated by the logic circuitry that checks the pre-defined conditions/events based on inputs from the temperature sensor and the pressure sensor. The controller can stop the charging and/or discharging of the battery. The controller can also put the battery in a dormant stage wherein the battery can be slowly and safely discharged.

The disclosed system can be incorporated in a single/standalone battery or a combination of battery cells, such as a power bank. In a power bank, multiple battery cells are used in combination to provide more power. The power bank can have a common charging circuitry. The disclosed system can provide for the isolation of a single cell in a power bank, such that a single cell can be stopped without affecting the other cells in the power bank. Each cell in the power bank can be monitored for temperature and pressure. Alternatively, the disclosed system can monitor the cutoff of the power bank from the external power source and/or load. For example, if the temperature rises above a set temperature or if the pressure inside the shell rises above a set pressure, the micro-controller of the disclosed system can automatically shut off the power supply from the battery electrodes to the external connectors. At the same time, the system can short out the two external connectors of the battery, so if the battery is in a series configuration in a battery bank, then the whole battery bank will not fail, and instead, only one battery/supercapacitor can be turned off. The disclosed system can be incorporated into the housing of the power bank. In case, the disclosed system is incorporated into a stand-alone battery, the system can be encased in a shell of the battery.

It is a critical feature of the invention that the disclosed system upon shutting down a battery cell/capacitor can put the same in a dormant state of slow discharge through a load resistor, also a part of the disclosed system. This avoids any deterioration in the condition of the battery and further rise in temperature or pressure. Moreover, a warning can be shown by the system to indicate that the battery cell has a defect or is kept not operational/isolated by the disclosed system. Thus, a user can check the faulted battery and can repair/replace the same if faults are found. Otherwise, if no faults in the battery can be found, the battery can be made operational again. The user can reset the disclosed system to make the battery operational. For example, a dedicated switch can be provided to reset the system. Alternatively, the power supply to the battery can be turned off and on to reset the disclosed system. Still, in an alternate implementation, a sequence of steps, such as turning the power on and off twice can be used to reset the system.

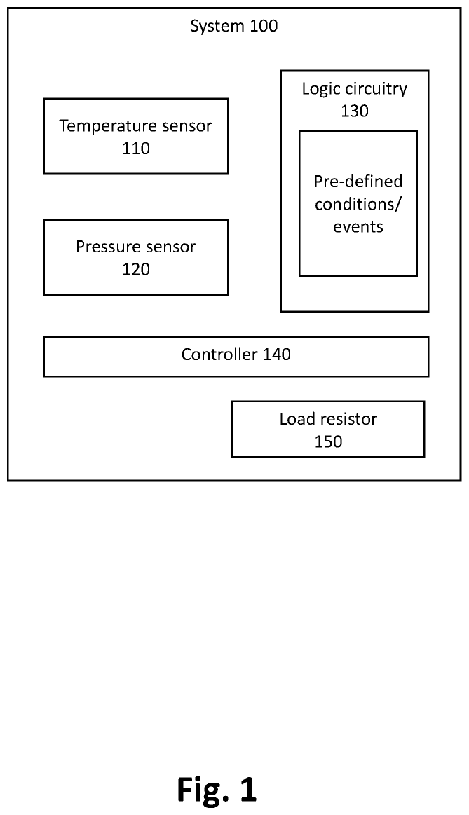

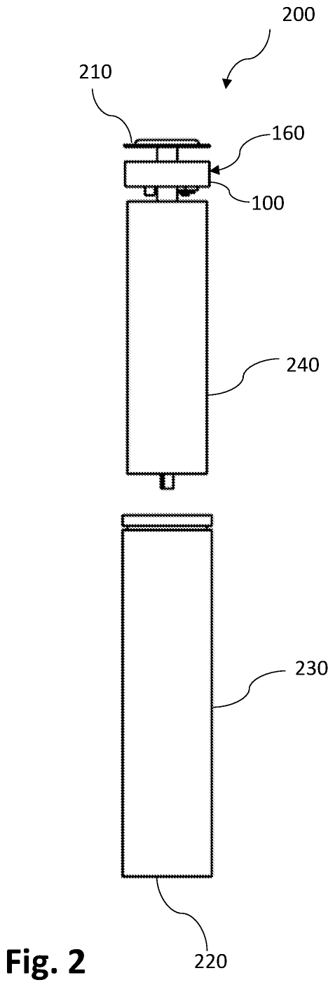

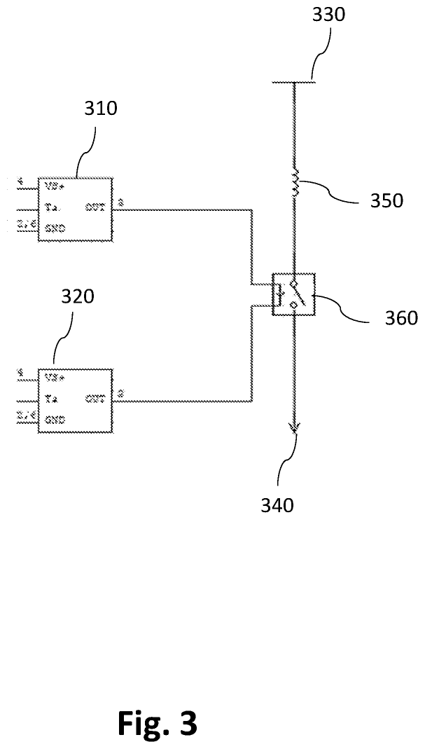

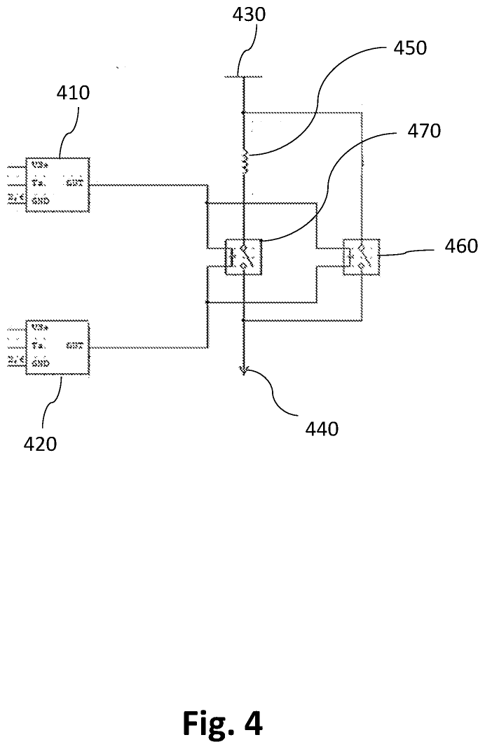

Referring to FIG. 1 is a block diagram showing an exemplary embodiment of the present invention. The system 100 includes a temperature sensor 110, a pressure sensor 120, a logic circuitry 130, a controller 140, and a load resistor 150. The logic circuitry can include predefined conditions/events, such as threshold temperature and pressure. The system can be implemented in a form of a printed circuit board. FIG. 2 is a partially exploded view of a typical battery 200 incorporating the disclosed system 100. The battery 200 can include a cathode 210, an anode 220, a casing 230, and electrodes 240. It is understood that not all the components of the battery are shown in FIG. 2. The battery can include any component known for use in the batteries without departing from the scope of the present invention. The disclosed system 100 in the form of PCB is encased with a housing 160 of the disclosed system that contacts the casing 230 for dissipation of heat. An example of a pressure sensor is the MPR™ series MicroPressure commercially available from Honeywell™ which is a miniature piezoresistive silicon pressure sensor. It has a very small form factor and wide pressure ranges. The temperature sensor can be a micro resistor type, such as Glass Sealed Diode NTC Thermistor MF58. The sensors may be very small in size so that the overall PCB size can be small enough to fit inside a standard battery. The power MOSFET can also be built onto the PCB for switching currents. The heat generated by the MOSFET must be dissipated to prevent damage to the PCB. Thermally conductive epoxy, such as EP30TC from Masterbond™ can be used. The epoxy may also be electrically insulative to prevent any short circuits. The temperature sensor and the pressure sensor can extend from the PCB to operate. When the pressure or temperature exceeds a set limit as determined by the logic circuitry, a positive voltage can be fed into the gate of the MOSFET, this causes the MOSFET to switch on. The MOSFET can then switch the main MOSFET off by connecting its gate to the ground. This stops the charging or discharging of the battery or capacitor. FIG. 3 shows a circuit diagram of an implementation of the disclosed system in a power bank and FIG. 4 is a circuit diagram showing the implementation of the disclosed system in a standalone battery. FIG. 3 shows a micro pressure sensor 310, a micro temperature sensor 320, a cathode 340, an anode 330, coated electrodes 350, and a MOSFET switch 360. FIG. 4 shows a micro pressure sensor 410, a micro temperature sensor 420, a cathode 430, an anode 440, coated electrodes 450, a MOSFET switch A 460, and a MOSFET switch B 470.

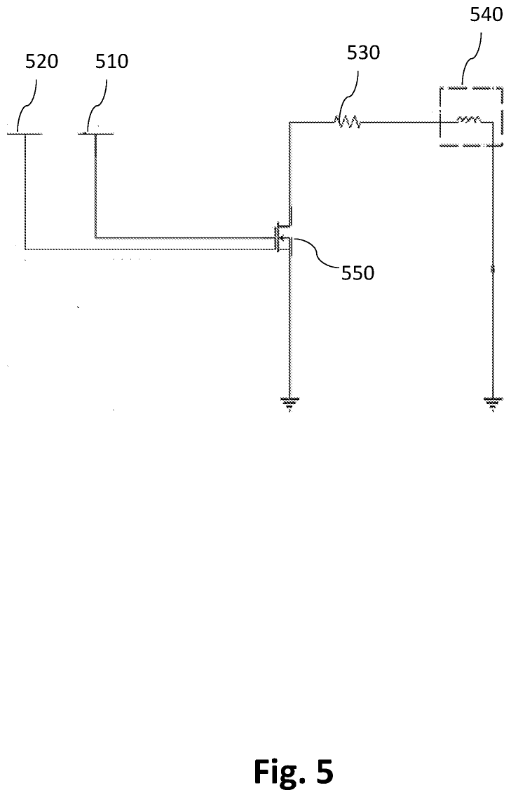

For safety, the disclosed system can provide for the slow discharge of a defaulted battery using the load resistor. For example, the load resistor can be a CR2512-JW-101ELF 100 Ohm 1-watt chip resistor. The chip resistor can be installed on the PCB with one other component i.e., an N channel MOSFET BF 998. As described before, the PCB can be encased in a thermally conductive epoxy, such as Duralco 128 epoxy. This PCB forms the second layer of the battery protection module. FIG. 5 shows a circuit diagram illustrating the working of the load resistor, the diagram shows an input for temperature sensor 510, an input for pressure sensor 520, a load resistor 530, a battery/capacitor electrode 540, and a dual gate MOSFET 550. The first terminal of the load resistor is connected to the Battery/capacitor electrode. The second terminal is connected to the ground through a dual gate N channel MOSFET. The N channel MOSFET has inputs from the pressure sensor and temperature sensor. When the pressure or temperature reaches a set limit, it outputs a voltage that switches the MOSFET ON. This connects the load resistor to the ground and the voltage across it drops by 4.5 volts. While 0.5-volt drops across the MOSFET. As shown the load resistor can be about 100 ohms in the valve so that the power can be dissipated in the resistor as heat. This power dissipated is (voltage drop×current flow) through the resistor. The current flow through the resistor can be according to the Ohm law I=V/R. Hence, when I=5/100=0.05 Amp, the power dissipated is equal to 4.5×0.05=0.225 watts or 0.225 joules per second.

In one case, a 6-amp hour cell with 3.65 volts contains approximately 79200 joules of energy. At this rate, the Load resistor can slowly discharge the battery in 79200/0.225=360,000 seconds or 100 hours or approximately 4 days. This slow discharge of the battery may be necessary so the load resistor does not go above its power rating of 1 watt, and the battery shell can dissipate that heat to the environment without a noticeable increase in temperature.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A safety system for batteries and/or supercapacitors, the safety system comprises:
a housing;
a controller encased within the housing, the controller configured to cease charging and/or discharging of one or more battery cells, the controller is configured with a threshold temperature and a threshold pressure for the one or more battery cells;
a pressure sensor configured to sense a current pressure of the one or more battery cells in near real-time;
a temperature sensor configured to sense a current temperature of the one or more battery cells in near real-time;
a logic circuitry operably coupled to the pressure sensor and the temperature sensor, the logic circuitry configured to compare the current temperature and the current pressure of the one or more battery cells to the threshold temperature and the threshold pressure respectively, the logic circuitry operably coupled to the controller,
wherein the controller is configured to:
receive a signal from the logic circuitry, the signal indicative of the current temperature or the current pressure exceeding the threshold temperature or the threshold pressure respectively; and
in response to the signal, ceasing the charging and/or discharging of the one or more battery cells.

2. The safety system according to claim 1, wherein the safety system further comprises:
a load resistor configured to dissipate energy as heat, wherein the controller is configured to:
in response to the signal, place the one or more battery cells in a dormant state and slowly cause the one or more battery cells to discharge through the load resistor.

3. The safety system according to claim 1, wherein the safety system further comprises one or more MOSFETS, the one or more MOSFETS operably coupled to the controller and configured to stop the charging and/or discharging of the one or more battery cells.

4. The safety system according to claim 1, wherein the battery is a power bank, the one or more battery cells comprise a plurality of battery cells, wherein the controller is configured to isolate a single battery cell of the plurality of battery cells of the power bank.

5. The safety system according to claim 1, wherein the battery is a standalone battery, the one or more battery cells comprises a single cell, and the safety system is configured to be encased with a shell of the standalone battery.

6. The safety system according to claim 5, wherein the housing is in contact with the shell for dissipating heat to the shell.

7. The safety system according to claim 1, wherein the safety system further comprises a thermally conductive epoxy, the housing is filled with the thermally conductive epoxy.

8. A method for enhancing safety of batteries and/or supercapacitors, method comprises:
providing a safety system comprising:
a housing;
a controller encased within the housing, the controller configured to cease charging and/or discharging of one or more battery cells, the controller is configured with a threshold temperature and a threshold pressure for the one or more battery cells;
a pressure sensor configured to determine a current pressure of the one or more battery cells in near real-time;
a temperature sensor configured to sense a current temperature of the one or more battery cells in near real-time;
a logic circuitry operably coupled to the pressure sensor and the temperature sensor, the logic circuitry configured to compare the current temperature and the current pressure of the one or more battery cells to the threshold temperature and the threshold pressure respectively, the logic circuitry operably coupled to the controller,
wherein the controller is configured to:
receive a signal from the logic circuitry, the signal indicative of the current temperature or the current pressure exceeding the threshold temperature or the threshold pressure respectively, and
in response to the signal, ceasing the charging and/or discharging of the one or more battery cells.

9. The method according to claim 8, wherein the safety system further comprises:
a load resistor configured to dissipate energy as heat, wherein the controller is configured to:
in response to the signal, place the one or more battery cells in a dormant state and slowly cause the one or more battery cells to discharge through the load resistor.

10. The method according to claim 8, wherein the safety system further comprises one or more MOSFETS, the one or more MOSFETS operably coupled to the controller and configured to stop the charging and/or discharging of the one or more battery cells.

11. The method according to claim 8, wherein the battery is a power bank, the one or more battery cells comprise a plurality of battery cells, wherein the controller is configured to isolate a single battery cell of the plurality of battery cells of the power bank.

12. The method according to claim 8, wherein the battery is a standalone battery, the one or more battery cells comprises a single cell, and the safety system is configured to be encased with a shell of the standalone battery.

13. The method according to claim 12, wherein the housing is in contact with the shell for dissipating heat to the shell.

14. The method according to claim 8, wherein the safety system further comprises a thermally conductive epoxy, the housing is filled with the thermally conductive epoxy.

15. A battery comprising:
a safety system for keeping the battery safe, the safety system comprises:
a housing;
a controller encased within the housing, the controller configured to cease charging and/or discharging of one or more battery cells, the controller is configured with a threshold temperature and a threshold pressure for the one or more battery cells;
a pressure sensor configured to determine a current pressure of the one or more battery cells in near real-time;
a temperature sensor configured to sense a current temperature of the one or more battery cells in near real-time;
a logic circuitry operably coupled to the pressure sensor and the temperature sensor, the logic circuitry configured to compare the current temperature and the current pressure of the one or more battery cells to the threshold temperature and the threshold pressure respectively, the logic circuitry operably coupled to the controller,
wherein the controller is configured to:
receive a signal from the logic circuitry, the signal indicative of the current temperature or the current pressure exceeding the threshold temperature or the threshold pressure respectively; and
in response to the signal, ceasing the charging and/or discharging of the one or more battery cells.

16. The battery according to claim 15, wherein the safety system further comprises:
a load resistor configured to dissipate energy as heat, wherein the controller is configured to:
in response to the signal, place the one or more battery cells in a dormant state and slowly cause the one or more battery cells to discharge through the load resistor.

17. The battery according to claim 15, wherein the safety system further comprises one or more MOSFETS, the one or more MOSFETS operably coupled to the controller and configured to stop the charging and/or discharging of the one or more battery cells.

18. The battery according to claim 15, wherein the battery is a standalone battery, the one or more battery cells comprises a single cell, and the safety system is configured to be encased with a shell of the standalone battery, the housing is in contact with the shell for dissipating heat to the shell.

19. The battery according to claim 15, wherein the safety system further comprises a thermally conductive epoxy, the housing is filled with the thermally conductive epoxy.
